(19) United States
(12) Patent Application Publication
(10) Pub. No.: US 2009/0249433 A1
(43) Pub. Date: Oct. 1, 2009

(54) SYSTEM AND METHOD FOR COLLABORATIVE MONITORING OF POLICY VIOLATIONS

(76) Inventors: Janardan Misra, Bangalore (IN); Indranil Saha, Kolkata (IN)

Correspondence Address: HONEYWELL INTERNATIONAL INC.;PATENT SERVICES, 101 COLUMBIA ROAD, P O BOX 2245, MORRISTOWN, NJ, 07962-2245, US

(21) Appl. No.: 12/057,855

(22) Filed: Mar. 28, 2008

(51) Int. Cl. G06F 21/00

(52) U.S. Cl. 726/1

(57) ABSTRACT

A computer implemented system and method is used to receive user reports regarding potential security policy violations that describe observations by the user, the type of policy violation, and an identification of another user with potential knowledge of a security policy violation. A payoff matrix may be formed for each user submitting a user report regarding potential as well as actual security violations and for users identified in such reports, wherein the payoff matrix reflects payout data for reported and unreported security policy violations. The payoff matrix may be used to both reward and punish reporting behaviors.

### BACKGROUND

In an organization, protecting assets is of prime importance. The assets of an organization range from the physical resources like infrastructure, computing devices, printers etc to logical assets like software source code, intellectual property (IP) and so on. With the increasing size of many organizations having dynamically changing physical and logical asset bases, designing appropriate security policies and their enforcement to maintain confidentiality and integrity of these assets is becoming increasingly difficult. One of the noticeable limitations of the existing security frameworks is the separation of responsibilities. Currently a user base of the assets is differentiated from the system administrators, who design and enforce these policies.

### BRIEF DESCRIPTION OF THE DRAWINGS

FIG. 1 is a block diagram of a system for tracking and rewarding reporting of security policy violations according to an example embodiment.

FIG. 2 illustrates a user interface providing a mechanism for user reporting of perceived security policy violations according to an example embodiment.

FIG. 3 illustrates a data structure that corresponds to a payoff matrix for rewarding and/or punishing users as per their reporting behavior on security policy violations according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. The term “computer readable media” is also used to represent any means by which the computer readable instructions may be received by the computer, such as by different forms of wired or wireless transmissions. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

Therefore, it appears a natural proposition that if securing confidentiality and integrity of an asset is considered a collective responsibility of the users having shared access rights on it, the security enforcement would enhance positively. For example, a malicious user passing on the sensitive IP related information to an unauthorized source could be better monitored and reported for doing so by the associated team members, who have probably better knowledge of it or can better detect it than the centrally administered monitoring mechanisms.

To make the users responsible for the security of the assets, a plausible approach may be to involve everyone in different aspects of security management including threat perception and monitoring the violation of policies regarding the usage of the assets. Now-a-days, all these operations are mainly taken care by a limited group of central administrators. They define security policies, devise means to enforce them, and monitor to detect possible violations. However, a large enterprise wide organization typically has tens of thousands of employees with roles/tasks/permissions ranging in the order of hundreds of thousands, and more than a million assets (physical as well as logical) and contexts present at any point of time. Thus, understanding the security requirements for different groups and their enforcement for a large organization is not only difficult but also is error-prone. It would be a better solution, if different groups formed based upon emerging contexts and tasks can define their own security policies and are entrusted with collective monitoring of the policy violations.

To guide individuals and groups for collaborative enforcement and monitoring of security policies, there needs to be a well-defined and robust logical framework. This framework should be easy to follow for devising measures to ensure overall implementation of such collaborative monitoring efforts. Also as an organization's structure changes from time to time, the framework should be such that it can effectively adapt with the changes. Unfortunately existing models of security do not consider such collaborative aspects and thus there is a need to devise one such.

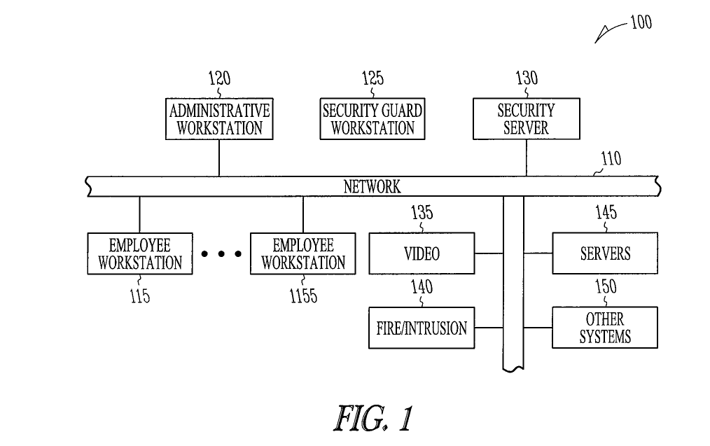

A system 100 for collaborative monitoring of policy violations is illustrated in FIG. 1. The system collects input from multiple sources regarding violations of security related policies designed to protect various assets, such as valuable tangible and intangible assets. Example of assets may include physical and logical assets. Physical assets may include computers, supplies, inventory, etc. Intangible assets may include assets like trade secrets, confidential information and other intellectual property. Policies related to protecting such assets may include the use of locked facilities, badges for accessing the facilities, marking of confidential information, questioning people in restricted facilities who are not recognized, password protection, and many other policies that are designed to protect and properly utilize assets.

System 100 in one embodiment, includes a network 110, and multiple devices coupled to the network 110 that deal with such policies and facilitate reporting of violations of the policies that may occur in a collaborative nature in order to encourage proper reporting of the violations. In one embodiment, the devices coupled to the network 110 include employee workstations 115, one or more administrative workstations 120, security guard workstations 125, a security server 130, video surveillance devices 135, fire/intrusion detection devices 140, further servers 145 and other systems 150.

System 100 is used to track assets, monitor security of facilities, and to collect and process information related to policy violations and perceived policy violations. The policy violation information may be automated in some instances, such as by fire/intrusion device 140, which may be a network of sensors, such as window and door sensors, badge readers, smoke and fire sensors, motion detectors, glass breakage detectors and other sensors generally associated with fire and intrusion detection systems 140. Policy violation information may include violations of physical space, windows left open, doors ajar, etc. Video surveillance system 135 may similarly detect violations of physical security policies. These violations may be processed by security server 130.

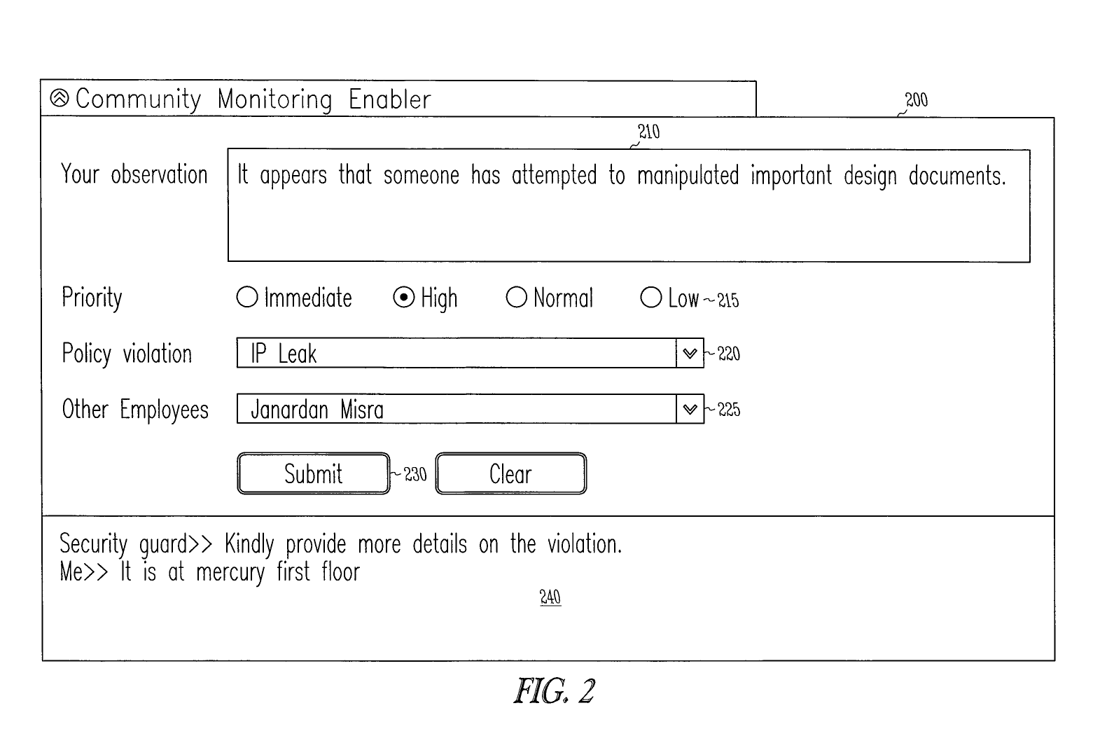

One example user interface for reporting policy violations is illustrated in FIG. 2 generally at 200. This user interface may be provided to employee workstations 115, administrative workstations 120, security guard workstations 125 and other devices that may be communicatively coupled to the network, such as by wireless devices, represented at 150.

User interface 200 may include a form having one or more data entry fields, such as free text entry space 210, where a user may describe an observation that may be related to a perceived violation of an asset security policy in plain language. In this example, the user typed: “It appears that someone has attempted to manipulate important design documents.” In one embodiment, a pull down menu may be provided at 210, allowing a user to select from multiple different apparent observations, such as tailgating through a security checkpoint, or unknown person in a restricted facility. At 215, a priority may be selected from bubbles indicating immediate, high, normal and low. At 220, a specific policy violation may be identified from a pull down menu. The example shown is “IP Leak”. Other employees who may have knowledge of the violation may be indicated at one or more pull down menus such as the one shown at 225. At 230, a user may select a button to either Submit or Clear the form.

In one embodiment, a message pane 240 may also be provided, which allows communication directly with a party responsible for policy or security violations. In this example interface 200, communication has been established with a security guard, who requested that the user: “Kindly provide more details on the violation”. The user responded in this case with “It is at Mercury first floor”, identifying a location where the perceived violation occurred. Further correspondence to further develop details regarding the perceived violation may occur.

There are several different examples of potential violations that may be reported using the user interface 200. Most organizations provide discretionary access control to its employees on certain computing resources e.g., personal laptops, desktops etc. with the policy those employees should duly lock these systems before leaving them unattended. It should be clear that for large organizations completely enforcing such a policy might not be feasible. If an employee does not follow the policy, and leaves his machine unlocked, another person including an unauthorized user who would have got access through tail-gating can access his machine, and cause potentially severe damage to the integrity and confidentiality of the data in that machine. Examples may include accessing some sensitive data (e.g., through auto-login or open email accounts), manipulating sensitive data (e.g., a disgruntled colleague having a priori knowledge), or erasing all the data by formatting the storage devices. So if some of his colleagues notice that and report this to the authorities, it might help in taking timely measures. And likelihood that a colleague would notice it is much higher than the limited surveillance infrastructure present around.

In short, detection of any physical resource in a state, which can potentially render system unsafe, may more realistically be detected by fellow employees than by limited security infrastructure.

Many corporate organizations provide their employees with photo printed smart cards to get access to different facilities in the organization. However, in a large organization, it is very difficult for the limited number of security staffs to monitor if everyone present in the organization is indeed using their own access cards.

If an intruder is somehow able to get such smart card of even a single employee for even a short while and enters the organization, then he can access most of the (physical) facilities that the employee could do using that card and could potentially cause serious threats. Nonetheless, it is highly likely that when such an intruder tries to access these facilities, other users familiar with the original user might possibly notice and report the presence of such unfamiliar intruder.

Consider further that a disgruntled employee having anti-social connections may make it feasible for the outside elements e.g., terrorist(s), to plant explosives by giving them his smart card exploiting the fact that an intruder using his access card might be not catch attention of others. Nonetheless likelihood that other employees might catch the anomaly is definitely higher than what can be achieved through limited surveillance infrastructure.

Suppose a (disgruntled) employee Jx obtains illegitimate access to sensitive data e.g., strategic documents, SRS, design documents, or source code, owned by his colleague Ix or jointly owned by them being in the same project etc., and attempts to either manipulate or transfer the data to unauthorized sources. Ix can report this as soon as he detects it and chances are higher that Ix would be able to detect such illegitimate access/manipulation/transfer by Jx more quickly than anyone else since Ix has the right knowledge base to determine the potential infringement with the structure of the data being associated with it.

Such an unauthorized access or attempts to manipulate and/or transfer data to unauthorized sources may arise in many ways and in most of the cases colleagues of such disgruntled employees are usually better equipped to detect and report it than any centralized machinery unless all the sensitive data is properly identified/tagged, centrally administered, and all the exit routes e.g., emails, memory storage devices etc. are either disabled or rigorously monitored—which undoubtedly is going to be highly cost sensitive.

A further example scenario includes: Jx knows that Ix usually backs up his source code into a USB device, which somehow is either allowed or is in vague in the organization as it eases the task of data transfer for the employees sometimes. So Jx borrows Ix's USB device in some other pretext and then copies the source code. Now Ix might realizes it soon by noticing the latest access timing records and so can report about Jx's attempt to access the data and thus the possibility of him infringing the sensitivity of the code.

Another scenario could be: Jx and Ix are involved in a sensitive project having restricted accesses on the associated design documents and Jx tries to persuade Ix that they could possibly share their designs without seeking required permissions, so Ix can report this to the higher management who can start monitoring activities of Jx henceforth. The knowledge of such Jx's behavior, which might be motivated by some other nefarious intensions, could possibly be detected early only by his colleagues as compared to any other means.

Another scenario may be as follows: Jx is working on a sensitive project and their lab has secure access. Fx a friend of Jx, tail gates him when this is not being monitored by the security staff or may be usually undetectable. Ix, who also works in the same lab and happens to be present in the lab around that time may detect this, and can report it to the security for taking appropriate measures against Jx and Fx for violating the lab security policies.

Consider an insider attack where Jx has somehow obtained access to a gateway which bypasses the usual restriction on internet accesses (or access outside the local intra-network) applicable to the employees, which is devised to handle requests on special purposes. And Jx uses this secret gateway to send sensitive data out of the organization. In case if Jx does so by being in an office with other users, it is more likely that he might be detected for doing so by the users over any other existing detection mechanism.

Ix and Jx, being part of R&D department are working on some sensitive projects. During their visit to a scientific conference, Fx, a friend of Jx, working for a competitor organization meets Jx unofficially and they discuss on their research work, where Ix happens to join them. Ix notices that they are informally discussing about the sensitive projects and in that discussion Jx is disclosing crucial IP details, which have not yet legally been patented assuming that it would never be possible for the organization to detect this. Ix on noticing this can possibly bring it to the notice to authorities and help the organization to protect the EPs as soon as possible and also warn Jx formally against such violations.

These scenarios are just a limited number of examples. Many such similar situations can always be speculated to justify formalizing the need for collaborative monitoring. Any social framework always provides wider scope for monitoring than any other automated infrastructure—to secure physical resources and importantly ‘interpreted’ logical resources, i.e., some data, importance of which is when considered with respect to specific contexts (e.g., design documents, source code etc.), where automated monitoring is either not feasible or would be very costly and might affect the productivity.

Let us now specify the system model on which the collaborative monitoring framework would be built. Let us consider that there are m subjects (processes/users) accessing shared resources according to specific policies. The policies may specify that an object has some access restrictions (e.g., copy operation on a specific File not allowed, mobiles with cameras are though allowed inside the campus but users must not operate those cameras, littering in public places not allowed etc), or may direct the behavior of the subjects. Preventing violation of these policies may require strong monitoring mechanism in place, which cannot be achieved always owing to the potential high costs associated with it. Therefore there arises a need for a collaborative monitoring and reporting to enhance the overall security of the system.

By collaborative monitoring we mean some kind of population centric monitoring mechanism whereby each member having access on an object is supposed to monitor for the compliance and specifically report the instances of non compliance or violations of the access restrictions on the object. The fundamental question, which arises in such a scenario, is as to how can such a collaborative monitoring framework be made effective since there is always a danger of overall complicity for deliberate ignorance on non compliance unless suitable pay-off are associated with all the relevant actions for the players (subjects/users).

A pay-off matrix based framework is used to formalize such a need, which is also often used as a basic tool in the Game Theory to model conflicting behaviors of the players. Underlying assumptions are specified prior to discussing the actual model.

Observability: Proposed model assumes that all genuine occurrences of violations of access restrictions have an impact on the system, which will always be observable (albeit might be later on with some delay). Thus we only consider such violations, which affect the state of the system and do not discuss other kinds of “passive” violations not affecting the system as far as the observable security of the system is concerned. This implies that the truth and falsity of any genuine occurrence of violations will always be verifiable.

Detectability: A violation is deemed to be detectable/detected only when it is reported to be done so (either by subjects/users or some monitoring device). Therefore if a violation occurs but is not reported by any of the witnesses (or captured by the monitoring device), it would be deemed undetected. Detection of a violation is thus temporally restricted and is different from the observable impact of it. A detectable violation would possibly enable inferring possible causal factors of it and might reduce the impact of the violation by enabling early curative measures.

Non-Reporting Violation: Another important assumption of the model is that non-reporting of an access restriction violation is a violation in itself and must invite punishment. It is assumed that in the absence of such treatment it might not be possible to give rise to a dynamically evolving and increasingly secure system with collective responsibility.

Policy Synthesis: Model assumes that access restrictions on the objects are defined a priory. Indeed devising access restrictions on objects is orthogonal to the monitoring process considered here. Nonetheless, it is possible that as a by product of the monitoring process, access restrictions, which have not been listed yet, can potentially be integrated into the framework. One such case might arise when certain sequence of accesses enable other access restriction violations so reporting the final access violation in terms of the scenarios consisting of the sequence of events (each event is an operation on an object by some subject) might give rise to new set of access restrictions.

Authentication: The members of community are assumed to be duly authenticated in order to determine whether resources are being legitimately access or not. Indeed very identification of access restriction violation depends on the authentication of the subjects as well as assets.

Quantifiable: The effect of an access violation should be quantified so that rewards and punishments can be appropriately defined in a consistent manner.

Model Execution: Model assumes that there exist some execution framework which could calculate the payoff matrices and enforce the rewards and punishments for the members as conceptualized in the model. Indeed in absence of such a mechanism, collaborative monitoring could hardly be deemed effective.

Knowledge completeness: Model assumes that members have knowledge of legitimate accesses and capability to detect and report genuine violations.

Certain socio-psychological aspects of behavior illustrate underlying reasons of the design of the model. There are numerous studies on the role of extrinsic motivation in individual and group behavior. Organizations usually face this question of as to how to keep its employees and teams sufficiently motivated through external rewards and policies.

The model is derived from a knowledge and insights into usual behavioral effects of various kinds of reward and punishments. Extrinsic rewards are usually important motivators to start new behaviors in the individuals. Group punishment mechanisms usually play an important role in the continuation of the intuitively justified community behaviors. Individuals in groups tend to exert pressures on other individuals to avoid themselves from paying community punishments owing to the violations caused by others.

Apart from rewards, punishments are also used as negative reinforcement tools for the individuals, who try to avoid such punishments by following the expected behaviors. Nonetheless, unless expected behaviors have been internalized by the individuals, the withdrawal of such negative reinforcements may put individuals at the risk of reverting back to the old situation.

On the other hand, group rewards usually do not produce much impact on the individual behaviors as people usually expect something unique for themselves in the rewards, which usually remain implicit with group rewards. Based upon the above facts, the payoff matrix model has been designed as an enabling mechanism for the collaborative monitoring.

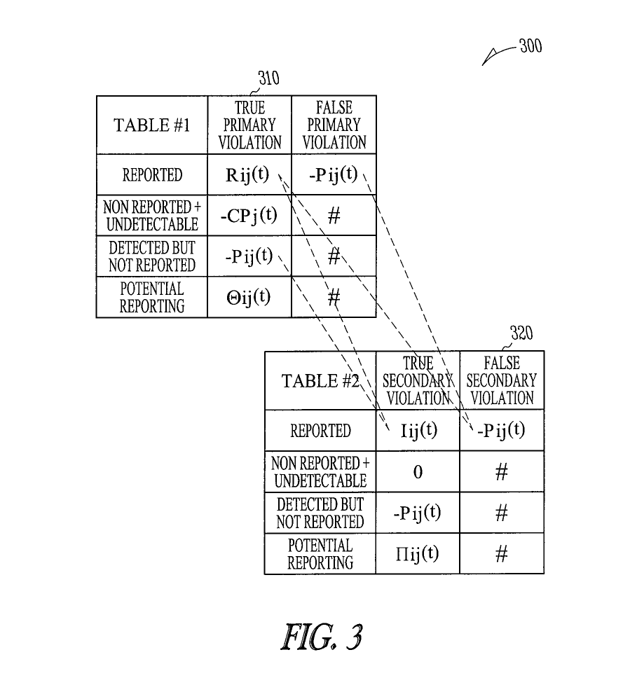

A data structure, referred to as a pay off matrix in one embodiment, for determining suitable reward/punishments on security violations reported by a user is illustrated in FIG. 3 generally at 300. The data structure 300 allows information to be obtained and processed to reward and optionally punish behaviors by users in an effort to encourage collaboration of user in the protection of assets and compliance and improvement of asset protection systems. In one embodiment, the data structure comprises a first table 310 and a second table 320. Each table contains data for different behaviors associated with real and potential policy violations. Table 310 has two columns having four rows of cells each containing time varying information regarding true primary violations and false primary violations. The rows categorize the reporting behavior of the players. The types of reporting in the rows comprises reported, not reported and undetectable, detected by but not reported, and potential reporting. Table 320 has columns for true secondary violation and false secondary violation, with the same rows.

Associate with each player, two types of time varying payoff matrices for the subset of objects, on which it has due access rights, as depicted in table 1 310 and table 2 320. The first pay-off matrix, table 1 310, defines the pay-offs associated with the i^{th} player Sᵢ for the j^{th} object Oⱼ on its reporting behavior for an access restriction violation. It is possible that different access restrictions on the same objects give rise to different violations (e.g., sharing a file with a peer inside the same organization might invite less punishment than sharing it with the external contacts) and thus each entry in the tables can be considered as a function of access restriction rules themselves. In general any security policy can be considered to define these payoff matrices where access restrictions policies are one such example.

The second pay-off matrix, table 2 320, defines the pay-offs associated with the i^{th} player Sᵢ for the j^{th} object Oⱼ on its reporting behavior for non reporting of an access restriction violation by some other player (see the assumption of Non-Reporting Violation as discussed before).

In table 1 310, first column—True Primary Violation—represents the case when an actual violation of access restrictions for Oⱼ has indeed occurred—impact of which is assumed to be observable later on. The second column—False Primary Violation—represents the false violations where player Sᵢ may act on the basis of a fabricated violation—a violation impact of which would never be observed. Such false violations might well be based on unreliable or unverified information sources, such as rumors. Reporting of these violations must invite punishment since they might be aimed towards falsely implicating others and are based upon non verifiable claims.

Rows categorize the reporting behavior of the players. Cases of reporting of violations after they have occurred and of potential violations reported in advance are considered, which might occur if suitable measures on implementing the access restrictions are not kept in place. The first three rows describe the first situation and the last row describes the later case where a possible violation is reported in advance.

When a violation occurs, either Si would report such a violation (by detecting it) [Row 1] or it will go unreported. The case of non-reporting is further classified into two categories: i) Row 2 represents the scenario where Sᵢ did not report and possible violation was undetectable (that is, no one else also reported it.) ii) Row 3 represents the scenario where Sᵢ detected a violation but did not report it, while some other player detected as well as reported it—to establish such a case—we need to consider another pay-off matrix as depicted in table 2, 320, which detection and reporting of such non reporting instances, which are necessary to make such reporting possibly mandatory. The last row is meant to capture a potential violation, which is supposedly possible under given security policy specifications.

In table 2 320, first column—True Secondary Violation—represents that case, where player Sᵢ detects a violation and also detects some other player(s) detecting the same violation though not reporting it. On the other hand, the second column in table 2 320—False Secondary Violation—represents that scenario, where player Sᵢ may act on the basis of a false or fabricated scenario and blame that such a scenario was witnessed by some other players but they did not report it.

Each payoff entry in the tables is now discussed.

Notation: Table#N:CELL[i,j] denotes the cell in i^{th} row and j^{th} column in Table#N, where row/column indexing starts from 1.

Note that all the entries in the tables, are functions of time, implying that their actual value at any time, might be dependent upon the previous events or past behaviors of the players. t represents the time variable with granularity of reporting occurrences.

Table#1:CELL[1,1]: The first cell in the table represents the scenario where player Sᵢ detects a violation and duly reports it and is rewarded with Rᵢⱼ(t). Any community based collaborative monitoring process can be made effective only when such reporting is associated with the due incentives at least to partly balance the reporting overhead, though, the actual value of the reward itself can be based upon the characteristics of the object Oⱼ and the nature of access violation and can very well vary over time. Indeed the reward can also depend upon the time delay between the actual occurrence of the violation and the time when it is reported. Increase in the trust levels or clearance levels for subjects as defined in various mandatory access control models can be considered as an example for such a reward.

In order to avoid false reporting of a true violation, we insist that in case majority of the players who detected and reported the violation also report that certain player did not actually detected the violation but is reporting the violation only to get share in the reward, his reward should be withdrawn and also that the reward should be distributed appropriately among all the reporting players.

Table#1:CELL[1,2]: The 2^{nd} cell in the 1^{st} row represents the scenario where player Sᵢ reports a false violation (self imagined violation to falsely implicate other users) so need to be punished with −Pᵢⱼ(t). Again actual value of such punishment itself can be based upon the characteristics of the object Oⱼ and the reported nature of access violation as well as the past behavior of the player Sᵢ, that is, in case Sᵢ is found to be repeatedly falsely implicating others, associated punishments should increase correspondingly. This can be formalized by defining Pᵢⱼ(t)=Pᵢⱼ(t−1)+c, where c is some positive constant. Notice that it is assumed that every genuine violation has some observable impact hence falsity of any such reported violation is verifiable (see the assumption of Observability).

Table#1:CELL[2,1]: The 1st cell in the 2^{nd} row represents the scenario where a violation occurs but it is not reported to be detected by any player. In such a case, each player pays a community price for it as denoted by −CPⱼ(t). Consider for example a sensitive source code is being copied and transferred by some of the members of the project team and none of those who had knowledge of it reported it. Since its impact would be anyway felt at some stage later, hence all the associated team members (players) need to bear some loss for this.

Such a community price to be paid by each associated member appears to be a mandatory component if such a model has to give rise to a dynamically evolving and increasingly secure system with collective responsibility. Again, in case, similar violations occur repeatedly, value of CPⱼ(t) might also increase. Otherwise if the frequency of similar violations decreases over time, value of CPⱼ(t) might also decrease.

Table#1:CELL[2,2]: This cell captures the scenario where no violation has actually occurred and it has not been reported. # denotes an undefined value.

Table#1:CELL[3,1]: The 1^{st} cell in the 3^{rd} row represents the scenario where player Sᵢ supposedly detects a violation but does not report it. Again for the effectiveness of any community based monitoring it is necessary that such non-reporting itself is treated as a violation. We term it as secondary violation to distinguish it from the primary violation of access restrictions on the secure objects.

Of course, such a claim would be valid only when there exists some other player Sⱼ, who also detects/witnesses the same violation and also detects that it is has been witnessed by player Sᵢ and Sⱼ reports it. Note that such a player Sⱼ can also be a neutral monitoring device by which such a claim can be derived as well as verified.

Therefore it is necessary to consider the cell Table#1:CELL[3,1] for player Sᵢ in conjunction with the cell Table#2:CELL[1,1] for some other player Sⱼ as discussed later.

−P′ᵢⱼ(t) denotes the price player Sᵢ need to pay for such non reporting of a violation. It can be argued that repeated occurrences of such non-reporting by a player must invite even harsher punishments, that is, P′ᵢⱼ(t)=c.P′ᵢⱼ(t−1), where c is some constant greater than one.

The difficult part in such a scenario is to validate the correctness of the claim reported by player Sⱼ that player Sᵢ witnessed the primary violation! In general it would require environment specific proofs (e.g., audio-video recordings etc) but we believe bare difficulty of proving such should not exclude such a scenario from the discussion.

Table#1:CELL[3,2]: This cell is meant to complete the table which captures an inherently false scenario where player Sᵢ does not report a false primary violation (which of course cannot be detected by anyone else!) It is also associated with undefined value #.

Table#1:CELL[4,1]: The 1st cell in the 4^{th} row represents the scenario complimenting the scenarios considered in the earlier rows. Here player Sᵢ proactively reports a potential violation and is therefore rewarded with θᵢⱼ(t). A collaborative monitoring process can be made more effective if players proactively point out potential sources of violations based upon their past experiences or analysis of security vulnerability under the existing security policy specifications.

Since a potential violation cannot be observed, therefore is assumed that it is logically possible to verify its truth by for example generating some hypothetical scenario where such violation would become possible. Examples include: for a newly created logical object, its owner subject/user might report potential access violations with the existing assess enforcement policies. Such reports may facilitate revision of security policy specifications in terms of access restrictions.

Table#1:CELL[4,2]: The 2^{nd} cell in the 4^{th} row represents the scenario where player Sᵢ reports a false potential violation. Similar to above, falsity of such a violation can be logically derived. We associate # with the value for the corresponding cell since it might not possible to prove that player Sᵢ reported such false potential violation only with malicious intentions and incomplete information or faulty analysis can well be the basis for that.

Table#2: Secondary Violations.

Table#2:CELL[1,1]: The first cell in the table represents the scenario where player Sᵢ detects a violation and also detects that some other player(s) detecting the same violation but not reporting it. We term it as secondary violation to distinguish it from the primary violation of access restrictions on secure objects.

This cell event can be true only if for the same player, event corresponding to Table#1 :CELL[1,1] is also true: it is a consistency check which states that secondary violation can be detected (and reported) only in conjunction with primary violation and not in isolation. There need also to be some reward associated with this as represented by rᵢⱼ(t).

Table#2:CELL[1,2]: The second cell in the first row represents the scenario where player Sᵢ reports a false secondary violation to falsely implicate other users that they witnessed some violation but did not report it so need to be punished with −pᵢⱼ(t).

False secondary violation cannot be considered in isolation and need to be considered only in conjunction with some true primary violation or in conjunction with a false primary violation. Therefore, this cell event is considered only if for the same player, event corresponding to Table#1:CELL[1,1] or Table#1:CELL[1,2] is also true: it is a consistency check.

Table#2:CELL[2,1]: The 1^{st} cell in the 2^{nd} row represents the scenario where a secondary violation occurs but it is not reported by any player. Since it appears that in general a secondary violation would not have serious negative impact on the whole community, therefore we chose to give 0 as value in this cell.

Table#2:CELL[2,2]: This cell captures the scenario where no secondary violation has actually occurred and it has not been reported as well. # denotes an undefined value.

Table#2:CELL[3,1]: The 1^{st} cell in the 3^{rd} row represents the scenario where player Si supposedly detects a secondary violation but does not report it. Again for the effectiveness of any community based monitoring it is necessary that such non-reporting itself is treated as violation.

This is the case where it is clear from the context of the primary violation that with all possibilities more than two players must have detected (including Sᵢ) such a violation but none of them reported it.

This must be distinguished from the situation discussed in Table#1:CELL[2,1], where a primary violation occurs but is not reported. This crucial difference is that there might exist certain situations, where primary violation would be by nature undetectable (e.g., littering in a public place in mid night with complete darkness), whereas there might exist scenarios where primary violation must have been witnessed by someone but was never reported (e.g., murder in a broad day light in a market area)

In such a case, each player pays again a community price for such complicity as denoted by −cpⱼ(t)

Notice that we do not demand here that again some third player detects and reports such non-reporting of a secondary violation since we assume that it might not be possible in practice to continue to such an extent and such consideration might indeed lead to an indefinite regression.

Again such provisions in the model would give rise to a dynamically evolving and increasingly secure system.

Table#2:CELL[3,2]: this cell is meant to complete the table which captures an inherently false scenario where player Sᵢ does not report a false secondary violation (which of course cannot be detected by anyone else!) It is also associated with undefined value #.

Table#2:CELL[4,1]: The 1^{st} cell in 4^{th} row represents the scenario where player Si reports a potential detection of a violation and also that some other player(s) detecting the same violation but not reporting it. This basically means that Sᵢ would be characterizing the potential behavior of certain other players who have greater probability of witnessing some violation. Consider, for example, security policy specifying that personal calls from a telephone are not allowed though access to it is not restricted. Based upon the past experiences, Sᵢ might report that some player S_{f} might make personal calls and it might do so in collusion with another player (friend) Sₕ, who would watch for the fact that while S_{f} makes the calls, no one else should detect it and Sₕ himself would not report it. We associate some reward πᵢⱼ(t) with it.

Table#2:CELL[4,2]: The 2^{nd} cell in the 4^{th} row represents the scenario where player Sᵢ reports a potential false secondary violation. Such scenarios does not appear to have any serious relevance, hence we associate # with it.

Assuming there are no external factors undermining the reporting behavior of individuals, using the payoff matrix model, at any point, individual gains from reporting true primary violations are always positive. This statement is supported by the following observation on the payoff matrix design: Suppose a player detects a primary violation. He would be faced with two choices—either he would proceed ahead and report the violation or he would not. In case of the former choice, he becomes entitled to receive the reward, which is a non negative value. Whereas, if he decides to remain silent on the violation, he is taking a risk of loosing some value as a part of community price (provided no one else reports it either) and also the risk of being punished for secondary violations in case there exist some other player who detected the violation and also detected that this player too had witnessed the same and the second player reports both of these violations.

In the case where there are no external factors (e.g., personal relationships with the violators, counter offers by the violator etc), which counter these payoff matrix based rewards and punishments and motivate a player to remain silent on the violation, he would always be better off by reporting the violations detected. Thus, the model design may be referred to as a safe design.

In one embodiment, subjects can either be actual users or can be software processes executing on behalf of the users, or combinations thereof. With the software processes as subjects with more than one process sharing certain logical objects, each process may be coupled with some monitoring component, which monitors the state of these shared objects on periodic basis or in synchronization with the base process. Alternately, a new design framework may allow designing of processes having normal execution together with monitoring, violation detection, and reporting capabilities. The interface 200 is such an example.

In one embodiment, the reward-punishment based framework for collaboratively monitoring the assets in an organization can be seamlessly integrated with any existing security infrastructure in place with minimal additions. The following elements may be used to implement various aspects of such a framework:
i) A network centric data collection mechanism, which can be used by the users to report violations and other relevant information (criticality level etc)
ii) Background support for simple arithmetic calculations to update payoff matrices
iii) Support for determining truth and falsity of the reported violations
iv) Support for determining and realizing payoffs, and
v) A mechanism to publish relevant information to generate awareness among users.

In case of users as actual subjects, implementation of the collaborative monitoring model demands suitable framework of disseminating the information on the proposed pay-off matrices to all the users as well as mechanisms for reporting the detection of primary or secondary violations. Associated rewards as well as punishments may be decided in a time varying manner to render the system adaptive together with adequate confidentiality measures for protecting the identities of the reporting users.

The parameters defining the rewards and punishments in the pay-off matrix may be determined based upon the characteristics of the objects and the subjects accessing the objects at any point in time. For example, with mandatory access control based security frameworks, employed for highly confidential assets (e.g., in military establishments), objects are differentiated according to their sensitivity levels, and the subjects are categorized based on their clearance levels. Usually user accesses are limited according to their clearance levels. There may be a number of schemes for defining the rewards and punishment criteria in terms of these levels. A simple scheme may be where a reward implies the increase in the clearance level of a particular user, and punishment results into decrease in his clearance level.

In reporting a violation, time is an important parameter. In general, the potential loss owing to a violation increases with increase in the delay. So, reporting time may also play a role in deciding the reward for reporting a violation. In one embodiment, time reporting is defined as the time difference between violation of a policy, and reporting of such violation. λ(s) denotes the clearance level of subject s, and λ(o) denotes the sensitivity level of an object o. The reward for reporting a violation of an access restriction on object o by subject s can be defined as follows:

λ(s)=λ(s)+f(λ(o), rₜ)

where f(λ(o), rₜ) is any monotonically non decreasing function of the sensitivity of object o, and rₜ, which denotes the reporting time. The value returned by the function increases with the increase in the value of λ(o), and decreases with the increase in the value of rₜ.

As a concrete example, if it is considered that there are N different levels for determining clearance and sensitivity levels, reward may be defined as:

λ(s)=[λ(s)]+[λ(o)/N]+[1−rₜ/R]

where R denotes the maximum delay possible before the violation would get detected.

A reward can alternately be defined in terms of reduction in loss owing to the timely reporting the violation. For example,

Reward(s, o)=α.(MaxLoss−ActualLoss)

where MaxLoss is the maximum possible loss, which could have happened if no user reported the violation, and ActualLoss is the actual loss after it was reported. α is some constant in the interval [0.1].

Other parameters for rewards and punishments may also be defined accordingly for any given system set up. Other parameters in the pay-off matrices can also be defined similarly. In general, deciding appropriate rewards and punishments may be dependent on the nature of the policy violations, their impact on the organization, ease of detecting them by the community members, and the nature of the groups associated with monitoring the policy violations etc. Nonetheless, some generic points may be extracted from the studies on extrinsic motivation.

Reward induced behaviors in individuals tend to stop once the rewards are withdrawn. This may be referred to as an over justification effect. This fact places important constraints on deciding the rewards. For example, it implies that rewards must not be withdrawn suddenly or rather gradually. Also, individuals evaluate the value of the rewards, which in turn determines their motivations for the tasks underlying the rewards, as compared to their current conditions (socio-economic status, responsibilities etc). Hence rewards catering to the satisfaction level of the individuals may be more effective. However, there are studies resulting into a Minimal Justification Principle, which implies that organization should give people small rewards for the things they should keep doing.

In some embodiments, community price works as a negative reinforcement mechanism on the group level. Hence it would motivate people to monitor violations to avoid paying such price. Therefore for it to be effective, community prices may be enforced strictly in the beginning though they should always be reduced as soon as reporting behavior has been adequately reinforced within the community. Similarly, punishments for false reporting and secondary violations work as negative enforcements for the individuals and hence may be strictly followed in the beginning and should not cease at any point of time so that individuals do not revert back to wrong behavior.

A safety property is a security property, which may be used to evaluate the effectiveness of the model. The general meaning of safety in the context of protection is that no access rights can be leaked to an unauthorized subject, i.e. given some initial safe state, there is no sequence of operations on the objects/resources, that would result in an unsafe state. Safety, in general is only decidable in very restricted cases. Unlike the usual security models, the model is actually a monitoring model, and robustness properties are more relevant to the model.

A monitoring policy is called probabilistically strongly robust if over a course of time the rate of access restriction violations steadily reduces. A monitoring policy is called probabilistically weakly robust if over a course of time the rate of detections and reporting of true violations reaches the rate of actual violations and the rate of false violations decrease.

Formally, let rᵥᵢₒ(t) correspond to the number of violations per unit time distributed over time, e.g., distribution on the number of violation per year. Similarly rate of reporting, say rᵣₑₚ(t) is distribution of the number of cases reported for true violations per unit time. Let r_{falses}_{_{—}}ₚᵣᵢ(t) and r_{false}_{_{—}}_{sec}(t) denote the rate distributions for false primary and secondary violations respectively. Then probability distribution for the occurrence as well as reporting of a true violation can be approximated as (rᵣₑₚ(t)/rᵥᵢₒ(t)).

Thus for a probabilistically strong robust monitoring:

Lim_{t→∞}rᵥᵢₒ(t)=0

Whereas for a probabilistically weakly robust monitoring model

Lim_{t→∞}(rᵣₑₚ(t)/rᵥᵢₒ(t))=1 and

Lim_{t→∞}r_{false}_{_{—}}ₚᵣᵢ(t)=0 and

Lim_{t→∞}r_{false}_{_{—}}_{sec}(t)=0

### Conclusion.

A reward-punishment based framework for collaboratively monitoring the assets in an organization, enables collaborative monitoring of policy violations. A pay-off matrix model is used to formalize such reward-punishment based framework for collaborative monitoring. The proposed payoff matrix model can be used to effectively decide appropriate policies for such collaborative monitoring in a time varying manner by adapting as per the changes in the policies as well as asset base in the organization. The framework may effectively complement existing security enforcement mechanisms, in particular, where the effectiveness of these enforcement mechanisms is rather limited, for example, owing to the large size of the asset base and technology limitations.

In various embodiments, a formal model enables collaborative monitoring of policy violations. The model may be used for any community/group/team based organizational structure. The model may be applicable to military organization, commercial organization, educational organizations, online communities, residential communities, and any other community/group with policies, violation of which is detrimental to the organization and therefore should be monitored. The model may be independent of policies, and may be applicable for all the security systems for which violations are to be monitored and reported. In further embodiments, the model may be used for updating existing policies and strengthening their enforcement mechanisms.

The model may be independent of the mechanism of reporting the violations. Many different reporting mechanisms may be incorporated into the model. In one embodiment, the model is a reward-punishment framework based upon the distinction between true and false violations of policies, proactive and active reporting of the policy violations, and considers non-reporting of witnessed violations also as violations. As per the model, a user reporting a violation that has truly occurred may be rewarded. If a user reports a violation that has not actually occurred, the user will be punished. If a violation has occurred, but no one reported the violation, everyone who is supposed to monitor for that particular policy violation would pay a community price. If a user reports about a potential violation of an existing policy, the user would be rewarded. That a user does not report a violation in itself considered a violation, and all the above-mentioned reward/punishment would be applicable to this violation, except only the case that if no one reports about such a violation but such a violation has occurred in reality, no common punishment would be applicable.

The reward/punishment may be of any kind. It may be monetary or any other kind of non-monetary reward/punishment consistent with local law in one embodiment. Reward/punishment parameters may be captured in a pay-off matrix. However, the model is suitable for any representation capturing reward/punishment for true and false reporting of actually occurred or potential violations of existing policies and non-reporting of detected violations of the existing policies. In further embodiments, reward/punishments may vary dynamically in the sense that based on the behavior of users and groups, changes in the organizational structure, changes in the existing policy scope and definition, and other environmental factors, the reward/punishment parameters for the users and policy violations may change with time. The model in one embodiment is independent of mechanisms of dynamically changing the reward/punishment. The mechanism of updating the reward/punishment need not affect the operational behavior of the model.

The Abstract is provided to comply with 37 C.F.R. §1.72(b) to allow the reader to quickly ascertain the nature and gist of the technical disclosure. The Abstract is submitted with the understanding that it will not be used to interpret or limit the scope or meaning of the claims.

1. A system comprising:
a plurality of workstations;
a server coupled to the workstations;
a user interface displayable on a workstation that facilitates reporting of perceived security policy violations, wherein the security policy addresses security of one or more assets; and
a payoff matrix data structure formed from the reported security violations that reflects payout data for reported and unreported security policy violations or potential violations.

2. The system of claim 1 wherein the payoff matrix comprises a first table corresponding to true primary violations and a second table corresponding to false primary violations.

3. The system of claim 2 wherein the payoff matrix further comprises data for true and false primary violations corresponding to reported violations, unreported undetectable violations, detected but not reported violations, and potential reporting of violations.

4. The system of claim 1 wherein the payoff matrix comprises a second table corresponding to true secondary violations and a second table corresponding to false secondary violations.

5. The system of claim 4 wherein the payoff matrix further comprises data for true and false secondary violations corresponding to reported violations, unreported undetectable violations, detected but not reported violations, and potential reporting of violations.

6. The system of claim 1 wherein the user interface comprises an input block facilitating description of observations related to potential and actual security policy violations.

7. The system of claim 6 wherein the user interface has an input block for identifying the type of security policy violation.

8. The system of claim 1 wherein the user interface includes an input block for identifying others with knowledge of a potential and actual security policy violation.

9. The system of claim 8 wherein a payoff is added for others identified as having knowledge of a potential security policy violation.

10. A system comprising:
a plurality of workstations;
a server coupled to the workstations;
a user interface displayable on a workstation that facilitates reporting of perceived security policy violations, wherein the security policy addresses security of one or more assets, wherein the user interface comprises an input block facilitating entry of text describing observations related to potential security policy violations, an input block for identifying the type of security policy violation, and an input block for identifying others with knowledge of a potential security policy violation; and
a payoff matrix data structure that reflects payout data for reported and unreported security policy violations, wherein the payoff matrix comprises a first table corresponding to true primary violations and to false primary violations and further comprises data for true and false primary and secondary violations corresponding to reported violations, unreported undetectable violations, detected but not reported violations, and potential reporting of violations.

11. The system of claim 10 wherein a payoff matrix is added for each user reporting a policy violation and for others identified as having knowledge of a potential security policy violation.

12. The system of claim 10 and further comprising a fire/intrusion detection system.

13. The system of claim 10 and further comprising a video surveillance system.

14. A computer implemented method comprising:
receiving user reports regarding security policy violations that describe observations by the user, the type of policy violation, and an identification of another user with potential knowledge of a security policy violation;
forming a payoff matrix for each user submitting a user report regarding security policy violations and for users identified in such reports, wherein the payoff matrix reflects payout data for reported and unreported security policy violations.

15. The method of claim 14 wherein the payoff matrix comprises a first table corresponding to true primary violations and to false primary violations.

16. The method of claim 15 wherein the payoff matrix further comprises data for true and false primary violations corresponding to reported violations, unreported undetectable violations, detected but not reported violations, and potential reporting of violations.

17. The method of claim 14 wherein the payoff matrix comprises a second table corresponding to true secondary violations and to false secondary violations.

18. The method of claim 17 wherein the payoff matrix further comprises data for true and false secondary violations corresponding to reported violations, unreported undetectable violations, detected but not reported violations, and potential reporting of violations.

19. The method of claim 14 and further comprising providing a user interface to users wherein the user interface comprises an input block facilitating entry of text describing observations related to security policy violations.

20. The method of claim 19 wherein the user interface has an input block for identifying the type of security policy violation, and an input block for identifying others with knowledge of a potential security policy violation.
